(19) United States
(12) Patent Application Publication
(10) Pub. No.: US 2011/0239111 A1
(43) Pub. Date: Sep. 29, 2011

(54) SPELL CHECKER INTERFACE

(75) Inventor: Douglas M. GROVER, Westminster, CO (US)

(73) Assignee: AVAYA INC., Basking Ridge, NJ (US)

(21) Appl. No.: 12/730,383

(22) Filed: Mar. 24, 2010

(51) Int. Cl. G06F 17/21; G06F 3/048

(52) U.S. Cl. 715/257; 715/764; 715/769

(57) ABSTRACT

A document is spelling and/or grammar checked and the errors are identified. The spelling and/or grammar errors are organized into groups of similar spelling and/or grammar errors. The groups of spelling and/or grammar errors are then presented for display to a user. The user can then view and spell and/or grammar check a whole group and/or individual errors in the group.

The system also allows for spelling and/or grammar checking of multiple documents at the same time. Checking of multiple documents is accomplished by a user interface that can check multiple documents serially or in parallel. This provides a robust mechanism for managing spelling and grammar checking of directories of documents and groups of documents. In addition to checking text documents, the system and method allow spelling and/or grammar checking of non-text documents, web pages, and other types of documents.

### TECHNICAL FIELD

The system and method relates to spelling and grammar checking systems, and in particular to spelling and grammar checking interfaces.

### BACKGROUND

Existing spell/grammar checking systems allow a user to open up a document and then perform a spelling/grammar check once the document is opened. The user is presented with a dialog box that identifies an initial potential spelling/grammar error. The user can then determine if he/she wants to ignore/change the error. The system then serially goes to the next identified spelling/grammar error in the document. This process is then repeated by the user until the user has serially gone through each error in the document. If the user only wants to check errors at the end of a document, he/she has to either put the cursor where they want to start spell checking or has to go through all the previous spelling errors before starting where they want.

Other systems allow text to be dragged and dropped into a text box or application that then identifies potential spelling/grammar errors. The spelling/grammar errors are then managed using similar known processes like those discussed above.

The problem with these systems is that they do not provide a way that a user can quickly get a summary of the spelling/grammar errors, a summary of similar errors (grouped together), and/or provide this type of interface for multiple documents. In addition, current systems don't allow a user to quickly perform the spelling/grammar check for a summary of grouped errors. These methods also fail to allow the user to drag-and-drop a file icon and perform the spelling check of a document/directory/URL and show the results to the user.

### SUMMARY

The system and method are directed to solving these and other problems and disadvantages of the prior art. A document is spelling and/or grammar checked and the errors are identified. The spelling and/or grammar errors are organized into groups of similar spelling and/or grammar errors. The groups of spelling and/or grammar errors are then presented for display to a user. The user can then view and spell and/or grammar check a whole group and/or individual errors in the group.

The system also allows for spelling and/or grammar checking of multiple documents at the same time. Checking of multiple documents is accomplished by a user interface that can check multiple documents serially or in parallel. This provides a robust mechanism for managing spelling and grammar checking of directories of documents and groups of documents. In addition to checking text documents, the system and method allow spelling and/or grammar checking of non-text documents, web pages, and other types of documents.

### BRIEF DESCRIPTION OF THE DRAWINGS

These and other features and advantages of the method will become more apparent from considering the following description of an illustrative embodiment of the system and method together with the drawing, in which:

FIG. 1 is a block diagram of a first illustrative system for providing spelling and/or grammar checking.

FIG. 2 is a block diagram of a second illustrative system for providing spelling and/or grammar checking.

FIG. 3 is a diagram of an illustrative user interface of a spell checker for spelling and/or grammar checking multiple documents serially.

FIG. 4 is a diagram of an illustrative user interface of a spell checker for spelling and/or grammar checking of multiple documents in parallel.

FIG. 5 is a diagram of dragging and dropping document icons to provide spelling and/or grammar checking of documents.

FIG. 6 is a flow diagram of a method for spell checking a document.

FIG. 7 is a flow diagram of a method for correcting user selected spelling errors.

### DETAILED DESCRIPTION

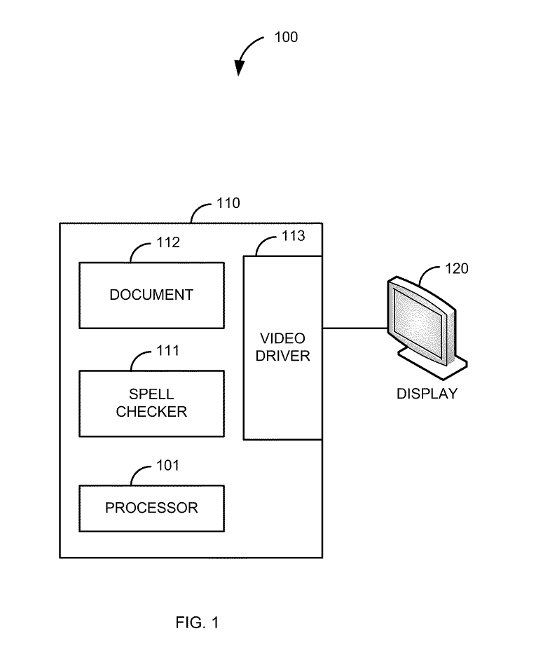

In this document, for simplicity, when referring to spell checking and/or spell correcting, spell checking/correcting can include only spell checking/correcting a document(s) 112, spelling and grammar checking/correcting a document(s) 112, only grammar checking/correcting of a document(s) 112, and the like. FIG. 1 is a block diagram of a first illustrative system 100 for providing spell checking. The first illustrative system 100 is shown as one example of a configuration that can be used. However, those skilled in the art will recognize that other systems will be obvious to one of ordinary skill in the art. The first illustrative system 100 comprises a computing device 110 and a display 120. The computing device 110 further comprises a processor 101, a spell checker 111, one or more documents 112, and a video driver 113.

The processor 101 can be any type of processing device/hardware such as a microprocessor, a multi-core processor, a micro-controller, and the like. The processor 101 executes the code/firmware of the spell checker 111. The spell checker 111 can be any type of hardware/software capable of identifying and correcting spelling errors in the document 112. The spell checker 111 can be a stand-alone application or can be embedded into another application, such as a word processor, an email program, and the like. The document 112 can be any type of document 112 such as a text document, an image document that contains text, a web page, a plurality of documents, a video that contains text, and the like.

The video driver 113 can be any type of driver that can generate video, such as a video card in a Personal Computer (PC), a display driver, and the like. The display 120 can be any type of device that can display an image such as a monitor, a Liquid Crystal Display (LCD), a plasma display, a television, and the like.

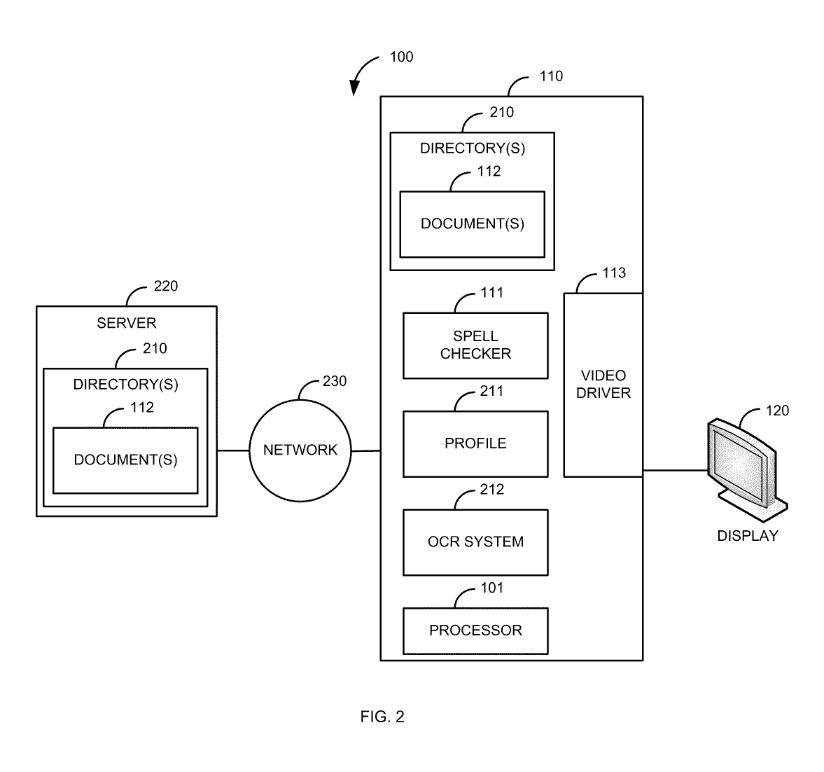

FIG. 2 is a block diagram of a second illustrative system 200 for providing spell checking. The second illustrative system 200 is shown as one example of a configuration that can be used. However, those skilled in the art will recognize that other systems will be obvious to one of ordinary skill in the art. The second illustrative system 200 further comprises a server 220 and a network 230. The server 220 can be any type of server such as a network server, a web server, an application server, a file server, and the like. The server 220 is shown with a directory(s) 210 that contains document(s) 112. The directory can be any type of grouping of document(s) 112 such as a file directory, the files in a flat file structure, a grouping of web pages, objects in a directory service, a grouping of images, a list of documents, and the like. The network 230 can be any type of network such as the Internet, a Wide Area Network (WAN), a Local Area Network (LAN), the Public Switched Telephone Network (PSTN), a cellular network, and the like.

The computing device 110 further comprises a directory(s) 210, a profile 211, and an Optical Character Recognition (OCR) system 212. The profile 211 can be any type of file and/or record such as a text file, information in a computer program, an Extended Markup Language (XML) document, and the like. The spell checker 111 reads attributes of profile 211 to determine specific portions of document(s) 112 to be spell checked. For example, after reading the profile 211, the spell checker 111 could only check a specific section of a document 112, edits made by a reviewer/user of a document 112, an abstract of a document 112, a specific paragraph of a document 112, a specific page of a document 112, and the like.

The OCR system 212 can be any type of system that can recognize language characters in an image, picture, video, and the like. The OCR system 212 can recognize characters of various languages. The OCR system 212 can convert the image characters to text for processing by the spell checker 111. The OCR system 212 can convert text back into an image document 112. For example, the OCR system 212 can convert a non-text document 112 into a text document 112 for spell/grammar checking/correction and then convert to spell corrected text document 112 into a different non-text document 112.

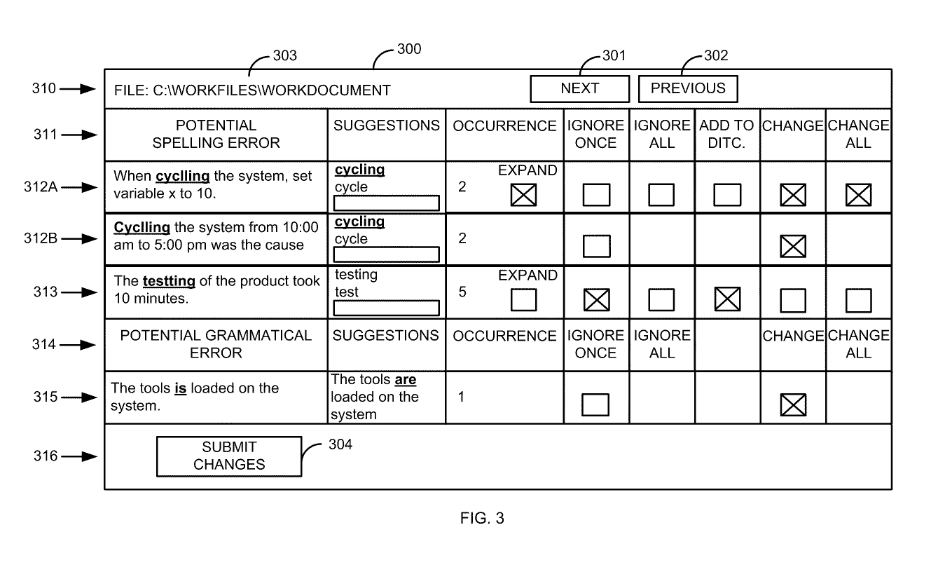

FIG. 3 is a diagram of an illustrative user interface 300 of the spell checker 111 for spell checking multiple documents 112 serially. User interface 300 comprises rows 310-316. The file row 310 comprises a path to the document 303, a next button 301, and a previous button 302. The path to the document 303 identifies the location of the current document 112 that is being spell checked. The next button 301 and the previous button 302 allow a user to spell check multiple documents 112. For example, if the user is spell checking two documents 112 (i.e., document 1 and document 2 (not shown)), after spell checking document 1, the user could click on the next button 301 and the user interface 300 would show the spelling errors in document 2. The path to the document 303 would now show the path to the location of document 2. If there is only one document 112 being spell checked, the next button 301 and the previous button 302 could optionally not be displayed or made so the user cannot select them.

Rows 311 and 314 describe the information that is displayed in the columns. Row 311 describes the information in the columns for spelling errors and row 314 describes the information in the columns for grammatical errors. For example, the Potential Spelling Errors column gives the context of where the spelling error occurred. Rows 312A-312B is an organized group of spelling errors where all the spelling errors in the group are shown. Row 313 is also an organized group of spelling errors where only one of the spelling errors in the group is shown. The groups can be organized based on different criteria such as the same misspelled word, the same type of grammatical error, all spelling errors, all grammatical errors, similar types of misspelled words, similar types of grammatical errors, and the like. In row 312A and 312B, the context (POTENTIAL SPELLING ERROR column) is the sentence where the spelling error of “cyclling” occurred. This way, a user can easily see the context of all the grouped spelling errors to determine if the user wants to correct all of the same type of spelling errors at the same time. For example, if the user wanted to correct the two “cyclling” errors at the same time, the user would select the CHANGE ALL check box (as shown) in row 312A. This is easier to do than in existing systems because the user can see the context of similar spelling errors at the same time versus having to cycle through each error one at a time that may be in different parts of the document 112.

The suggestions column describes potential corrections that the user can select to correct the spelling error. The user can select a specific error by selecting the presented suggestions. For example, the user has selected “cycling” (indicated by the underline) in rows 312A-312B. The user can also enter text in the text box instead of selecting a correction from a list as shown in the SUGGESTIONS column in rows 312A, 312B, and 313.

The OCCURRENCE column shows the number of occurrences of an error. For example, there are two occurrences of the spelling error “cyclling” as shown in rows 312A-312B. The first occurrence of the spelling error “cyclling” in row 312A also has an EXPAND check box, which is checked. When the “EXPAND” check box is checked, all the grouped spelling errors are shown. In this example, there are two “cyclling” errors in the file WORKDOCUMENT. If the EXPAND check box in row 312A were not checked, then row 312B would not be shown. An example of an unexpanded grouping of errors is shown in row 313 for the spelling error “testting.” The OCCURRENCE column for row 313 shows that there are 5 occurrences of the spelling error “testting” in the document 112 WORKDOCUMENT. However, since the EXPAND check box in row 313 is not checked, only one occurrence of the error “testting” is shown in user interface 300.

The IGNORE ONCE column allows the user to ignore individual spelling errors. The IGNORE ALL column allows the user to ignore all the spelling errors in a group (e.g., the group of “cyclling” errors shown in rows 312A-312B). The add to dictionary column (ADD TO DIC.) allows the user to add a particular error identified for a group to the dictionary. The CHANGE column allows a user to only correct a selected individual spelling error in a group. The CHANGE ALL column allows a user to change all the spelling errors identified in a group. The checkboxes in the user interface 300 can be implemented in various known ways, such as radio buttons and the like. For example, the CHANGE ALL and the IGNORE ALL could be radio buttons that toggle back and forth when the user selects one of the radio buttons. The user interface 300 can be designed using various constructs to those skilled in the art.

In row 315, there is only one grammatical error in the document 112 WORKDOCUMENT. Since there is only 1 occurrence of the grammatical error, there is not an EXPAND checkbox, an IGNORE ALL checkbox, or a CHANGE ALL checkbox in row 315. For grammatical errors, in row 315, the user can select the suggested correction, or can click on the suggested selection to edit the text where the grammatical error occurs. In this example, the grammatical error of using “is” instead of “are” in a sentence is identified in row 315. Similar to the spelling errors, row 315 also has IGNORE ONCE and CHANGE check boxes that work in a similar manner as in rows 312-313.

After the user has selected how he/she wants to correct the spelling/grammar errors, the user can then select the SUBMIT CHANGES button 304. The spell checker 111 detects the spelling/grammar selected by the user. The selected spelling/grammar errors are then corrected in the document 112 currently being spell checked (the document 112 shown in row 310 in the path to the document 303).

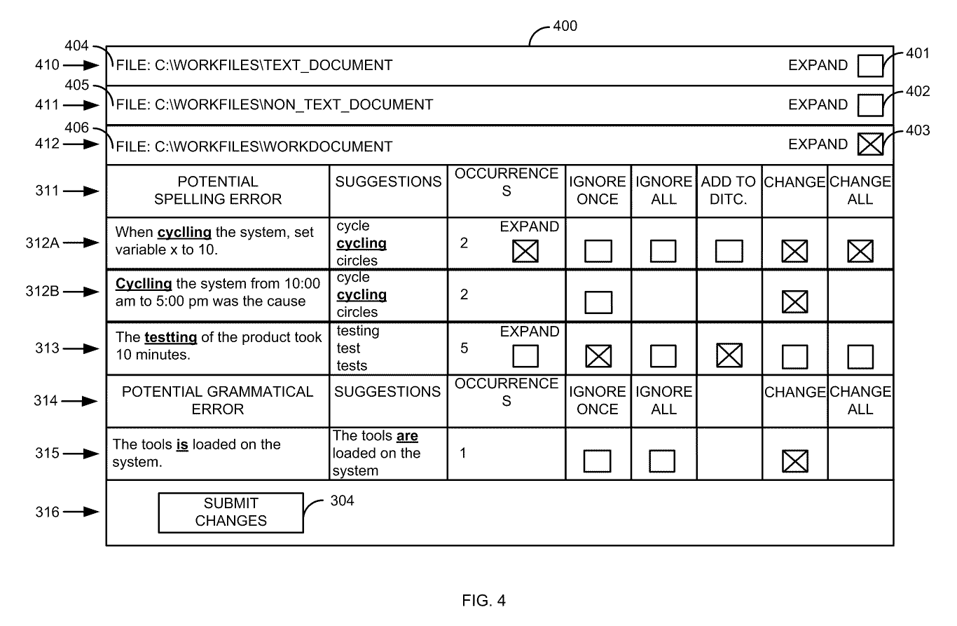

FIG. 4 is a diagram of an illustrative user interface 400 of the spell checker 111 for spell checking multiple documents 112 in parallel. FIG. 4 comprises the same rows 311-316 as shown in FIG. 3. However, the difference is that each document 112 that is being spell checked is shown separately in user interface 400, as shown in rows 410-412. Each of rows 410-412 show individual documents 112 that are being spell checked. The path document 404-406 gives the file path to each document 112 that the user can spell check. Each of the rows 410-412 has an EXPAND check box 401-403 to allow the user to correct spelling/grammar in a document 112. For example, EXPAND checkbox 403 has been checked by the user and the spelling/grammar error groups are shown in rows 312, 313, and 315. If the user clicked on EXPAND checkbox 403 again, rows 311-316 would be removed from user interface 400.

If the user checked checkbox 401, a similar display of groups (similar to rows 311-316, except based on the individual spelling/grammar errors in the document TEXT_DOCUMENT) would be shown in like manner below row 410 and before row 411 (i.e., between rows 410 and 411). In the same manner as previously discussed, the user can select which spelling/grammar errors to correct and then click on the SUBMIT CHANGES button 304 to correct the spelling/grammar errors for the associated document 112.

The user could click on each of the EXPAND checkboxes 401-403. A separate set of groups for each of the three files (shown in path to document 404-406) would be displayed along with an individual SUBMIT CHANGES button 304 for each file being spell checked. The user can then individually spell check each file via user interface 400.

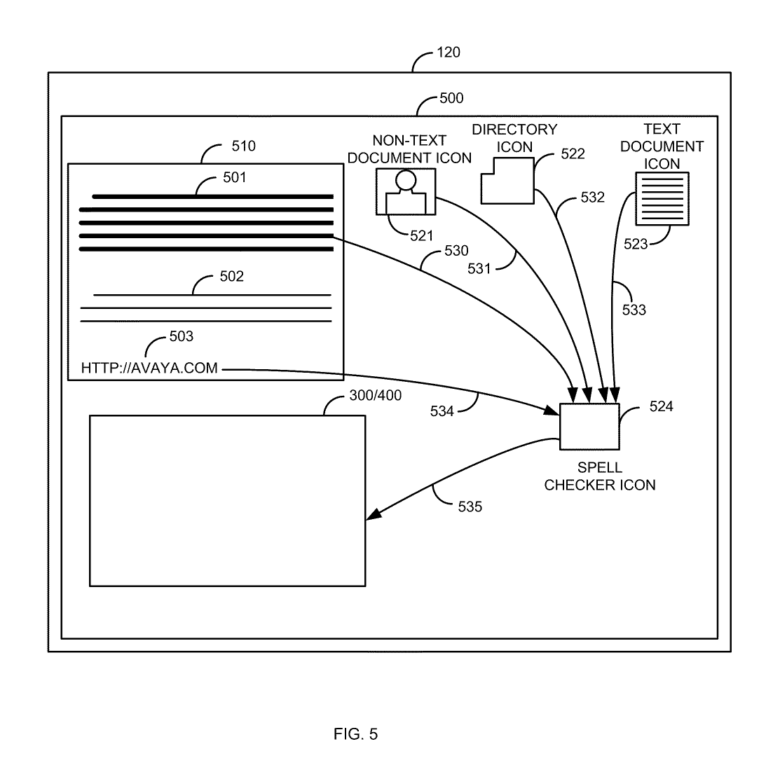

FIG. 5 is a diagram of dragging and dropping document icons to provide spell checking of documents 112. FIG. 5 comprises the display 120, a video screen 500 in the display 120, an open text document 510, a non-text document icon 521, a directory icon 522, a text document icon 523, a spell checker icon 524, and the user interface 300 or 400. The open text document 510 as shown (e.g., a text document opened by a word processing application) comprises selected text 501 (i.e., a portion of the text in the open document 510), non-selected text 502, and a Universal Resource Locator (URL) 503. Text in the open document 510 and the URL 503 can be selected by the user.

In this example, the spell checker icon 524 is used to initiate the spell checker 111. This can be done by a user clicking a mouse on the spell checker icon 524, touching the spell checker icon 524 on the video screen 500, and the like. Initiation of the spell checker 111 can be accomplished in other ways. For example, the user can select a portion of the text 501 and then drag-and-drop 530 the selected text 501 onto the spell checker icon 524 to initiate the spell checker 111, thus resulting in the display of the user interface 300 or 400 to the user.

The user can select the text document icon 523 and drag-and-drop 533 the text document icon 523 onto the spell checker icon 524 to initiate the spell checker 111 and display the user interface 300 or 400. The user can select the directory icon 522 and drag-and-drop 532 the directory icon 522 onto the spell checker icon 524 to initiate the spell checker 111 and display the user interface 300 or 400 to the user. If a directory icon 522 is dragged-and-dropped, the user will be able to spell check any documents 112 that have text and/or image text in the directory represented by the directory icon 522. What files and/or which portion of the files that are to be spell checked in a directory can be defined in the profile 211.

The user can select a non-text document icon 521 and drag-and-drop 531 the non-text document icon 521 on to the spell checker icon 524 to display the user interface 300 or 400. The OCR system 212 converts the non-text document represented by the non-text document icon 521 into a text document; this initiates the spell checker 111. The user can select a URL 503 and drag-and-drop 534 the URL 503 onto the spell checker icon 524 to display the user interface 300 or 400. The spell checker 111 can load the web page(s) to be spell checked. For example, if the loaded web page(s) are in Hyper Text Markup Language (HTML) or Extended Markup Language (XML), the spell checker 111 can spell check the text of the web pages based on attributes of the profile 211 (e.g., ignoring the HTML or XML tags). If the web page(s) contains images, OCR system 212 can convert text in images in the web page(s) into text for spell checking. Once the spell checker 111 has corrected errors in the web page(s), the spell checker 111 can repost the web pages to the server 220. If there were image documents that have been spell corrected, the OCR system 212 can convert the spell-corrected text into a new image document and post the new image document on the web page(s).

The user can, for example, select all the text (501, 502, and 503) in the open text document 510. The user could then drag-in-drop the selected text (now 501, 502, and 503) on the spell checker icon 524 (i.e., or drag-in-drop an icon for the open document (not shown) onto the spell checker icon 524). The spell checker 111 can now spell check all the text in the open text document 510 (501 and 502) and also spell check the URL 503. The text in the open text document 510 can be treated as one document 112 and the URL 503 in the open text document 501 can be treated as a second document 112 in the user interface 300 or 400. For example, the path to the document 303 would have an indicator of text in the document for the text portion (501 and 502). The user could then hit the next button 301 and the path to the document 303 would have an indicator of the URL 503. The user could then go back and forth between the text (501 and 502) and the URL 503 using the next button 301 and the previous button 302 in user interface 300.

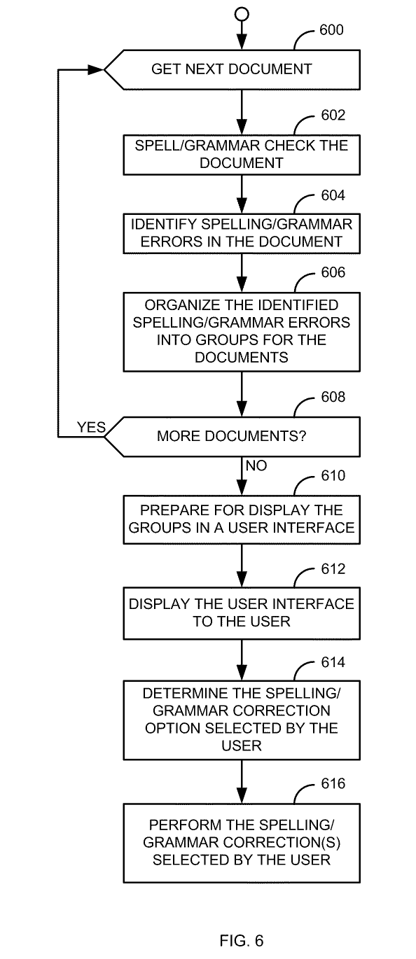

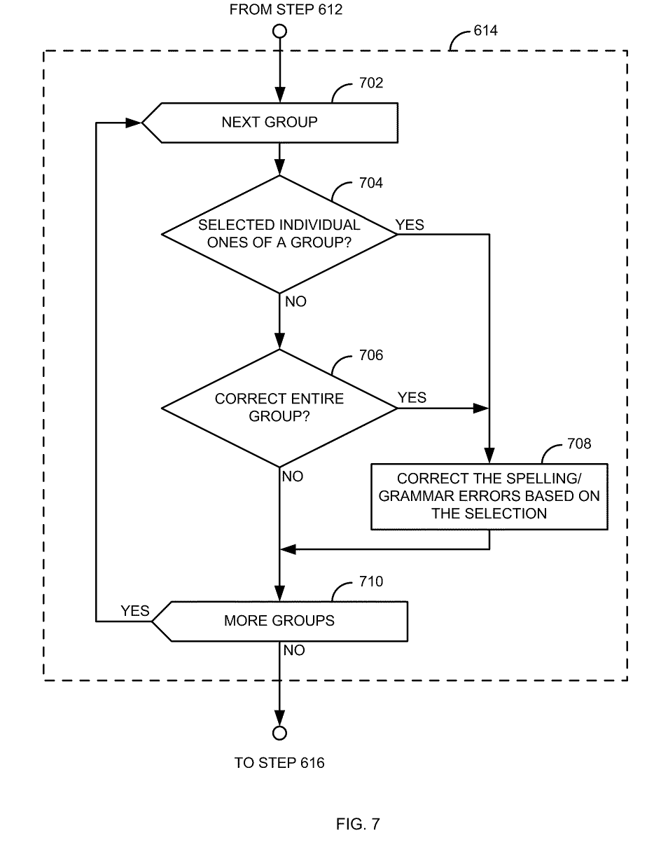

FIG. 6 is a flow diagram of a method for spelling and/or grammar checking a document 112. Illustratively, the spell checker 111, the video driver 113, the server 220, and the OCR system 212 are stored-program-controlled entities, such as a computer or processor 101, which performs the method of FIGS. 6-7 and the processes described herein by executing program instructions stored in a computer readable storage medium, such as a memory or disk.

The spell checker 111 gets 600 the next document 112 to spell check. The spell checker 111 can spell check one or more documents 112. The spell checker 111 does a spell/grammar check 602 on the document 112. The spell checker 111 identifies 604 spelling/grammar errors in the document 112. The spell checker 111 organizes 606 the spelling/grammars errors into groups (see rows 312, 313, and 315) for the document 112.

The spell checker 111 checks in step 608 to see if there are more documents 112 to spell/grammar check. If there are more documents 112 to spell/grammar check in step 608, the process goes to step 600 to get to the next document. Otherwise, if there are no more documents 112 to check in step 608, the video driver 113 prepares 610 for displaying the groups (see rows 312, 313, and 315 in FIG. 3 and FIG. 4) in the user interface 300/400. The user interface 300/400 is displayed 612 to the user. The spell checker 111 determines 614 (i.e., when the user clicks on the submit changes button 304) the spelling/grammar correction option(s) (e.g., if the user has selected the change all check box in FIG. 3/FIG. 4) selected by the user. The spell checker 111 performs 616 the selected spelling/grammar errors.

FIG. 7 is a flow diagram of a method for correcting user selected spelling errors. FIG. 7 is an expanded view of step 614 from FIG. 6. The spell checker 111 gets 702 the next group in the document 112 from step 700. The spell checker 111 determines in step 704 if individual ones of the group have been selected (e.g., the CHANGE check box in row 315 is selected). If individual ones of the group have been selected in step 704, the process goes to step 708. Otherwise, if individual ones of the group have not been selected in step 704, the spell checker 111 determines in step 706 if the user has selected to spell/grammar check the entire group (e.g., the CHANGE ALL check box on row 312A). If the user has not selected to spell/grammar check the entire group in step 706, the process goes to step 710. Otherwise, if the user has selected to spell/grammar check the entire group in step 706, the spell checker 111 corrects 708 the spelling/grammar errors based on the selection and the process goes to step 710. In step 710, the spell checker 111 determines if there are more groups to process. If there are more groups to process in step 710, the process goes to step 702. Otherwise, the process goes to step 616.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

Of course, various changes and modifications to the illustrative embodiment described above will be apparent to those skilled in the art. These changes and modifications can be made without departing from the spirit and the scope of the system and method and without diminishing its attendant advantages. The above description and associated Figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
a. identifying, by the processor, spelling and/or grammar errors in at least a portion of a document;
b. organizing, by the processor, the identified spelling and/or grammar errors into a plurality of groups, wherein the plurality of groups comprise at least one of the identified spelling and/or grammar errors; and
c. preparing for display by a video driver the plurality of groups for presentation at the same time in a user interface.

2. The method of claim 1 further comprising the step of: presenting the user interface in a display.

3. The method of claim 2, wherein at least one of the plurality of groups has a plurality of spelling and/or grammar errors and further comprising the step of:
detecting a selection to correct all of the spelling and/or grammar errors in the at least one of the plurality of groups.

4. The method of claim 2, wherein at least one of the plurality of groups has a plurality of spelling and/or grammar errors and further comprising the step of:
detecting a selection of individual ones of the plurality of spelling and/or grammar errors in the at least one of the plurality of groups for spelling and/or grammar correction.

5. The method of claim 2, wherein the at least a portion of the document is a web page and further comprising the steps of:
performing a spelling and/or grammar correction on the web page; and
reposting the spelling and/or grammar corrected web page.

6. The method of claim 2, wherein the at least a portion of the document comprises a plurality of documents and further comprising the step of:
identifying the plurality of documents in the user interface either serially or in parallel.

7. The method of claim 2, wherein the at least a portion of the document is a first non-text document and further comprising the steps of:
converting the first non-text document to a text document;
spelling and/or grammar correcting the text document; and
converting the spelling and/or grammar corrected non-text document into a second non-text document.

8. The method of claim 2, wherein at least one of the plurality of groups has a plurality of spelling errors and/or grammar errors and further comprising the step of:
providing a context for each of the plurality of spelling and/or grammar errors in the at least one of the plurality of groups.

9. The method of claim 1, further comprising the step of:
reading attributes of a profile, wherein the profile determines a specific portion of the at least a portion of the document to be spelling and/or grammar checked.

10. The method of claim 1, wherein the at least a portion of the document is a complete document, and further comprising the step of:
determining that an icon of the document was dragged-and-dropped onto a spell checker icon resulting in the initiating of step (a).

11. The method of claim 1, wherein the at least a portion of the document comprises text and a URL, and further comprising:
treating the text and the URL as separate documents in the user interface.

12. A computer readable medium having stored thereon instructions that cause a processor to execute a method, the method comprising:
a. instructions to identify spelling and/or grammar errors in at least a portion of a document;
b. instructions to organize the identified spelling and/or grammar errors into a plurality of groups wherein the plurality of groups comprises at least one of the identified spelling and/or grammar errors; and
c. instructions to display the plurality of groups for presentation at the same time in a user interface.

13. The method of claim 12, wherein at least one of the plurality of groups has a plurality of spelling and/or grammar errors and further comprising:
instructions to detect a selection to correct all of the spelling and/or grammar errors in the at least one of the plurality of groups.

14. The method of claim 12, wherein at least one of the plurality of groups has a plurality of spelling and/or grammar errors and further comprising:
instructions to detect a selection of individual ones of the plurality of spelling and/or grammar errors in the at least one of the plurality of groups for spelling and/or grammar correction.

15. The method of claim 12, wherein the at least a portion of the document is a web page and further comprising:
instructions to perform a spelling and/or grammar correction on the web page; and
instructions to repost the spelling and/or grammar corrected web page.

16. The method of claim 12, wherein the at least a portion of the document comprises a plurality of documents and further comprising:
instructions to identify the plurality of documents in the user interface either serially or in parallel.

17. The method of claim 12, wherein the at least a portion of the document is a first non-text document and further comprising:
instructions to convert the first non-text document to a text document;
instructions to spell and/or grammar correct the text document; and
instructions to convert the spelling and/or grammar corrected non-text document into a second non-text document.

18. The method of claim 12, wherein at least one of the plurality of groups has a plurality of spelling errors and/or grammar errors and further comprising:
instructions to provide a context for each of the plurality of spelling and/or grammar errors in the at least one of the plurality of groups.

19. The method of claim 12, further comprising:
instructions to read attributes of a profile, wherein the profile determines a specific portion of the at least a portion of the document to be spelling and/or grammar checked.

20. The method of claim 12, wherein the at least a portion of the document is a complete document, and further comprising:
instructions to determine that an icon of the document was dragged-and-dropped onto a spell checker icon resulting in the initiating of step (a).

21. The method of claim 12, wherein the at least a portion of the document comprises text and a URL, and further comprising:
instructions to treat the text and the URL as separate documents in the user interface.

22. A system comprising:
a. spelling and/or grammar checker configured to identify spelling and/or grammar errors in at least a portion of a document, and organize the identified spelling and/or grammar errors into a plurality of groups, wherein the plurality of groups comprises at least one of the identified spelling and/or grammar errors; and
b. a video driver configured to prepare for display the plurality of groups for presentation at the same time in a user interface.
